(19) United States
(12) Patent Application Publication
(10) Pub. No.: US 2004/0087411 A1
(43) Pub. Date: May 6, 2004

(54) Method for assembling rotor and sliding structure of rotor and oscillator

(76) Inventors: Kiyoji Minegishi, Chita-gun (JP); Masataka Nakaoka, Ohbu-shi (JP); Sakae Mitsufuji, Ohbu-shi (JP)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/633,691

(22) Filed: Aug. 5, 2003

(30) Foreign Application Priority Data
Aug. 5, 2002 (JP) 2002-227611

(51) Int. Cl. F16H 57/08

(52) U.S. Cl. 475/331

(57) ABSTRACT

A method for assembling a rotor and a sliding structure of a rotor and an oscillator which allow easy assembly with an improvement in productivity. The method is one for assembling a rotor of a power transmission device having an oscillator and a rotor rotatably assembled into said oscillator, said rotor making rotations and oscillations of said oscillator, comprising the steps of: loading a plurality of rolling elements to be arranged between the eccentric body and the oscillator via a retainer for positioning the rolling elements from inside the retainer; and assembling the eccentric body into inside the loaded rolling elements.

### BACKGROUND OF THE INVENTION

1. Field of the Invention

The present invention relates to a method for assembling a rotor and a sliding structure of a rotor and an oscillator. In particular, the invention relates to a method for assembling a rotor and a sliding structure of a rotor and an oscillator which allow easy assembly with an improvement in productivity.

2. Description of the Related Art

Conventionally, a speed reducer (power transmission device) has been known, which has an oscillator and a rotor rotatably assembled into said oscillator. The rotor makes rotations and oscillations of said oscillator.

As an example of a speed reducer, a speed reducer as shown in FIGS. 9 and 10 has been proposed which comprises eccentric bodies (rotor) capable of eccentric rotations about the center axis of input shaft and external gears (oscillators) capable of oscillations along with the rotations of the eccentric bodies (for example, see U.S. Pat. No. 5,286,237). FIG. 9 is a sectional side view of a speed reducer 100. FIG. 10 is a sectional view taken along the line X-X of FIG. 9.

This speed reducer 100 comprises an input shaft 102, eccentric bodies (rotors) 106a and 106b, and external gears (oscillators) 108a and 108b. Sliding portions between the eccentric bodies 106a, 106b and the external gears 106a, 108b are provided with respective sliding structures 120 (110, 111, 112) to be described later.

The input shaft 102 is rotatably supported by ball bearings 130a and 130b. The eccentric bodies 106a and 106b are integrally formed on the outer periphery of the input shaft 102 between the ball bearings 130a and 130b, with a predetermined phase difference therebetween (180°, in this example). The eccentric bodies 106a and 106b can make eccentric rotations with the input shaft 102 about the center axis L4. The two external gears 108a and 108b are fitted to the outer peripheries of the eccentric bodies 106a and 106b via the sliding structures 120, respectively. The two external gears 108a and 108b can make oscillatory rotations along with the rotations of the eccentric bodies 106a and 106b.

FIG. 11(A) is an enlarged partial view of a sliding structure 120 provided in the speed reducer 100. FIG. 11(B) is a side view of the sliding structure 120 as seen in the direction of the arrow XIB in FIG. 11(A).

This sliding structure 120 is composed of an inner ring 110, rollers (rolling elements) 112 of cylindrical shape, and a retainer 111.

The inner ring 110 is an annular member having a hollow 110a. A peripheral groove 110b capable of accommodating the rollers 112 partially is formed in part of the outer periphery of the inner ring 110.

The retainer 111 is an annular member having a diameter somewhat larger than that of the inner ring 110, and is arranged to surround the outer periphery of the inner ring 110. The retainer 111 is perforated with a plurality of pockets 111a capable of accommodating and retaining the rollers 112 with predetermined regular gaps ΔL1 therebetween.

The rollers 112 are loaded into the pockets 111a of the retainer 111 from the outer side for retention. Besides, the rollers 112 are partially accommodated in the peripheral groove 110b of the inner ring 110 and arranged in contact with the inner periphery of the external gear 108a, 108b and the peripheral groove 110 of the inner ring 110. The rollers 112 can rotate about themselves in the direction R3 in the diagram, and can revolve in the circumferential direction of the circle C2 in the diagram as retained by the retainer 111.

As above, in the speed reducer 100, the sliding portions between the eccentric bodies 106a, 106b and the external gears 108a, 108b are provided with the sliding structures 120 so that the rotations of the external gears 108a and 108b are facilitated.

FIG. 12 is a sectional view of a conventional flexible meshing planetary gear speed reducer, another example of a speed reducer.

This flexible meshing planetary gear speed reducer 151 comprises a rigid internal gear 152 having an annular shape, a flexible external gear (oscillator) 154 having a cup-like shape, and a wave generator (rotor) 158 having an elliptic profile. The flexible external gear 154 is arranged inside the rigid internal gear 152. The wave generator 158 is fit into the flexible external gear 154 via a sliding structure 156.

This wave generator 158 bends the flexible external gear 154 into an elliptic shape so that external teeth 154A of the flexible external gear 154 mesh with internal teeth 152A of the rigid internal gear 152 at two points. The meshing points are moved circumferentially so that a relative rotation corresponding to a difference between the numbers of teeth of the external teeth 154A and the internal teeth 152A occurs between the flexible external gear 154 and the rigid internal gear 152.

Even in such a flexible meshing planetary gear speed reducer 151, the sliding structure 156 smoothens the rotation of the flexible external gear 154.

In the conventionally known speed reducer 100 and 151, however, the assembly of the rotor (the eccentric bodies 106a, 106b, the wave generator 158, and so on) has required that the plurality of rollers 112 be loaded into the pockets 111a one by one from the outer side of the retainer 111. This has resulted in inefficient assembly operations, with limitations on productivity improvement.

### SUMMARY OF THE INVENTION

The present invention has been achieved to solve the foregoing problems. It is thus an object of the present invention to provide a method for assembling a rotor and a sliding structure of a rotor and an oscillator which allow easy assembly with an improvement in productivity.

The foregoing object of the present invention has been achieved by the provision of a method for assembling a rotor of a power transmission device having an oscillator and a rotor rotatably assembled into said oscillator, said rotor making rotations and oscillations of said oscillator. The method comprises the steps of: loading a plurality of rolling elements to be arranged between the rotor and the oscillator via a retainer for positioning the rolling elements, from inside the retainer; and assembling the rotor into inside the loaded rolling elements.

Rolling elements are typically used in plural, and considerable labor would thus be required when the rolling elements were loaded from outside one by one. According to the present invention, the rolling elements are loaded from inside the retainer at a time, which allows short-time assembly operation with an improvement in productivity. Moreover, in the assembly method of the present invention, the rolling elements are merely positioned by the retainer, not loaded fixedly. The rolling elements can thus be fine adjusted in position at the time of assembly of the rotor so that the assembly of the rotor is facilitated as compared to the case where the rollers are loaded fixedly.

Incidentally, “the step of assembling the rotor into inside the loaded rolling elements” may be effected by various methods. For example, the step may comprise the substeps of: inserting an inner support ring into inside the loaded rolling elements, the inner support ring being arranged radially inside a circle connecting the rolling centers of the rolling elements and perforated with a plurality of inner pockets for allowing the rolling elements to be partially exposed to its inner side; inserting the rotor into an interior space of the inner support ring. Here, the inner support ring restrains the radially inward movement of the rolling elements, makes the retainer portable with the rolling elements loaded therein. The assembly of the rotor is thus facilitated further. Futhermore, the substeps may include the substep of pulling out the inner support ring.

Moreover, the step of assembling the rotor into inside the loaded rolling elements may comprise the substeps of: inserting a dummy rotor pressing said loaded rolling elements outward; and inserting the rotor so as to replace the dummy rotor. This configuration also facilitates the assembly of the rotor. Incidentally, a dummy rotor may have almost the same shaft diameter as that of said rotor.

Furthermore, the step of assembling the rotor may be followed by the step of fitting a rotor ring for restraining axial movement of the rolling elements onto an outer periphery of the rotor. Consequently, the rolling elements can be retained with higher reliability.

The present invention also provides a sliding structure of a rotor and an oscillator of a power transmission device having an oscillator and a rotor rotatably assembled into said oscillator, said rotor making rotations and oscillations of said oscillator. The sliding structure comprises: a plurality of rolling elements arranged between the rotor and the oscillator; and a retainer having a support ring being arranged radially outside a circle connecting the rolling centers of the rolling elements and perforated with a plurality of pockets for allowing the rolling elements to be partially exposed to its outer side. A protrusion for restraining axial movement of said rolling elements is provided on only one axial end of an outer periphery of the rotor. Consequently, it becomes possible for the rotor to be inserted in an axial direction and to function as means for positioning the retainer and the rolling elements. Moreover, the inner support ring can prevent the rolling elements from slipping off in the radially inward direction, so that the rolling elements can be retained with higher reliability at the time of assembly.

Moreover, when said retainer has the side ring being extended from an axial end of the support ring to avoid the rolling elements from slipping off, the side ring can prevent the rolling elements from slipping off in the axial direction.

When an inner periphery of the support ring is located at least 1.05 times radially outside the circle connecting the rolling centers of the rolling elements, the gaps between adjoining rolling elements can be reduced. As a result, it becomes possible to increase the number of rolling elements arranged between the rotor and the oscillator and increase the diameter of the rolling elements for higher load capacity of the sliding structure.

According to the present invention, it is possible to provide a method for assembling a rotor and a sliding structure of a rotor and an oscillator which allow easy assembly with an improvement in productivity.

### BRIEF DESCRIPTION OF THE DRAWINGS

FIG. 1 is a sectional side view of a speed reducer to which the sliding structure according to an embodiment of the present invention is applied;

FIG. 2 is an enlarged partial view around the sliding structures of FIG. 1;

FIGS. 3(A) and 3(B) are diagrams showing a, sliding structure in FIG. 1;

FIG. 4 is a diagram showing the retainer part of FIG. 3 alone;

FIG. 5 is a sectional side view of a second speed reducer to which the sliding structure according to the embodiment of the present invention is applied;

FIG. 6 is an enlarged partial view around the sliding structures of FIG. 5;

FIGS. 7(A) to 7(E) are schematic diagrams showing the procedure for assembling an eccentric body according to a first example of the embodiment of the present invention;

FIGS. 8(A) to 8(D) are schematic diagrams showing the steps of assembling an eccentric body according to a second example of the embodiment of the present invention;

FIG. 9 is a sectional side view of a speed reducer to which a conventional sliding structure is applied;

FIG. 10 is a sectional view taken along the line X-X of FIG. 9;

FIGS. 11(A) and 11(B) are enlarged partial views of the sliding structure in FIG. 9; and

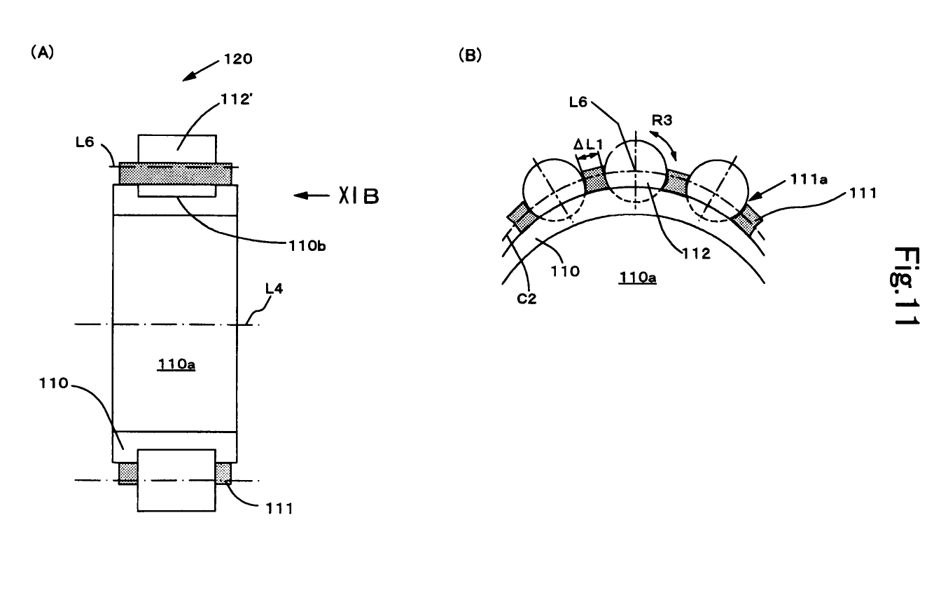

FIG. 12 is a sectional side view of a conventional flexible meshing planetary gear speed reducer.

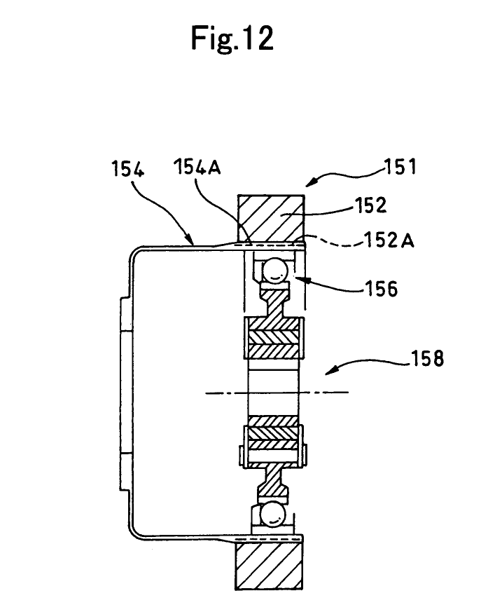

### DETAILED DESCRIPTION OF THE PREFERRED EMBODIMENT

Hereinafter, an embodiment of the present invention will be described with reference to the drawings.

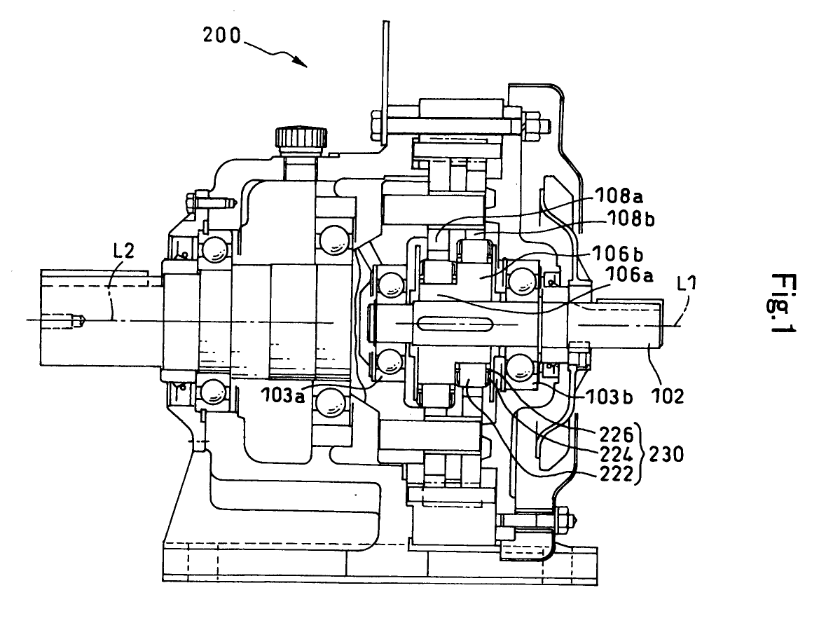

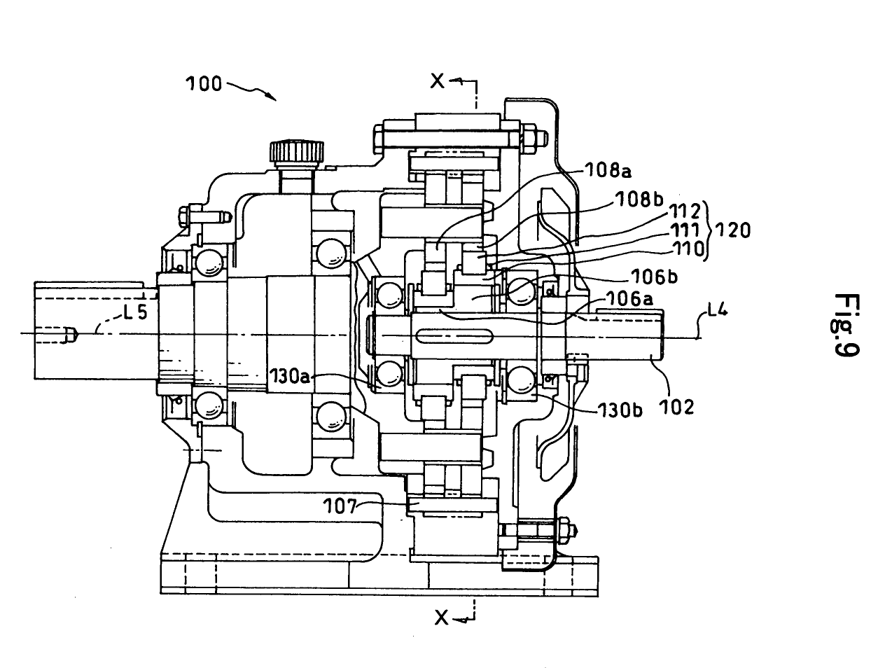

FIG. 1 is a sectional side view of a speed reducer (power transmission device) 200 to which the sliding structure according to an embodiment of the present invention is applied. This diagram corresponds to FIG. 9 seen above.

The speed reducer 200 shown in FIG. 1 is substantially the same as the speed reducer 100 shown in FIG. 9 above, except in the sliding structures of the eccentric bodies (rotors) and the external gears (oscillators). Thus, identical or similar parts will be designated by the same reference numerals in the diagram. Detailed description thereof will be omitted.

The speed reducer 200 comprises an input shaft 102, eccentric bodies 106a and 106b, and two external gears 108a and 108b. The eccentric bodies 106a and 106b are capable of eccentric rotations about the center axis L1. The two external gears 108a and 108b are capable of oscillations along with the rotations of the eccentric bodies 106a and 106b. The eccentric bodies 106a, 106b and the external gears 108a, 108b are provided with respective sliding structures 230 (222, 224, 226) therebetween.

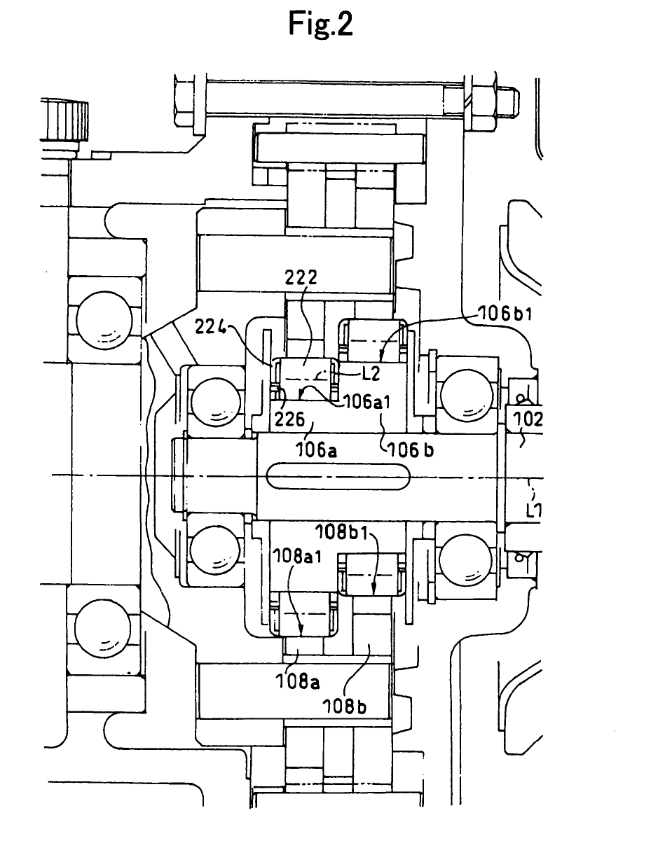

Hereinafter, description will be given in detail of the sliding structures 230 with reference to FIGS. 2 to 4. In FIG. 1, the two sliding structures, provided between the eccentric body 106a and the external gear 108a and between the eccentric body 106b and the external gear 108b, have the same structure. Thus, the following description will deal with the sliding structure 230 that is arranged between the eccentric body 106a and the external gear 108a.

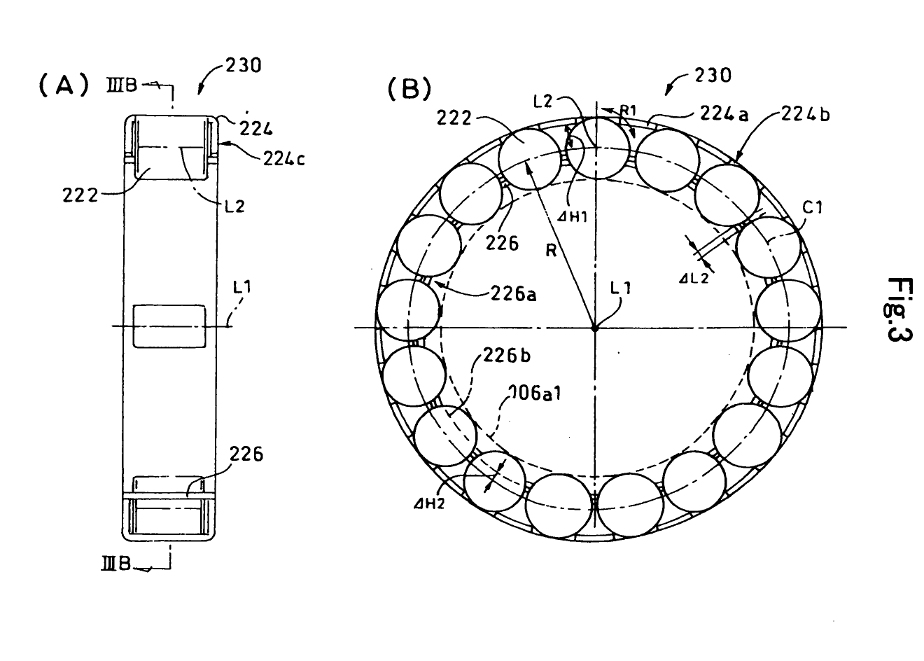

FIG. 2 is an enlarged partial view around the sliding structure 230 of the speed reducer 200 in FIG. 1. FIG. 3(A) is a sectional side view of the sliding structure 230. FIG. 3(B) is a sectional view taken along the line IIIB-IIIB of FIG. 3(A).

The sliding structure 230 comprises a plurality of rollers (rolling elements) 222, a retainer 224, and an inner support ring 226.

In this example, the rollers 222 have a generally cylindrical shape, and are accommodated in the retainer 224 to be described later in such a state that they can rotate about themselves in the direction R1 in FIG. 3(B). The rollers 222 are prevented from slipping off radially inward (toward the eccentric body 106a) by the inner support ring 226 to be described later. The rollers 222 are arranged in plural between the eccentric body 106a and the external gear 108a with regular gaps (ΔL2, in the diagram) therebetween. They can make rolling contact directly with both an outer periphery 106a1 of the eccentric body 106a and an inner periphery 108a1 of the external gear 108a.

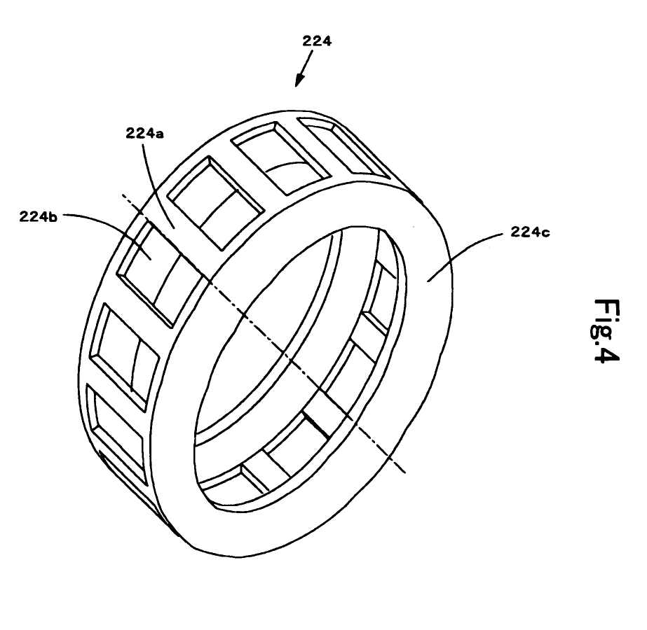

The retainer 224 has a support ring 224a. With respect to a circle C1 that connects the rolling centers L2 of the rollers 222, the support ring 224a is arranged radially outside by ΔH1 in the diagram. As shown in a perspective view of the retainer 224 (FIG. 4), this support ring 224a is perforated with a plurality of rectangular pockets 224b. The pockets 224b allow the rollers 222 to be partially exposed to outside the support ring 224a. Moreover, both axial ends of the support ring 224a are extended into a pair of side rings 224c which prevent the rollers 222 from slipping off axially.

The inner support ring 226 is an annular member having a diameter somewhat smaller than that of the support ring 224a of the retainer 224. With respect to the circle C1 which connects the rolling centers L2 of the rollers 222, the inner support ring 226 is arranged radially inside by ΔH2 in FIG. 3(B). The inner support ring 226 is perforated with a plurality of rectangular inner pockets 226a for allowing the rollers 222 to be partially exposed to its inner side. Incidentally, the inner periphery 226b of the inner support ring 226 has a diameter larger than that of the outer periphery 106a1 of the eccentric body 106a.

Consequently, neither of the retainer 224 and the inner support ring 226 falls on the circle C1 which connects the rolling centers L2 of the rollers 222. Then, it is the spaces of gap ΔL2 alone that come between the rollers 222 on the circle C1.

In the sliding structures 230 according to the embodiment of the present invention, the plurality of rollers 222 are arranged between the eccentric bodies 106a, 106b and the external gears 108a, 108b so as to be capable of direct rolling contact with both the outer peripheries 106a1, 106b1 of the eccentric bodies 106a, 106b and the inner peripheries 108a1, 108b1 of the external gears 108a, 108b, respectively. Since the rollers 222 alone are interposed between the eccentric bodies 106a, 106b and the external gears 108a, 108b, it is possible to increase the outer diameters of the input shaft 102 and the eccentric bodies 106a, 106b without changing the inner diameters of the external gears 108a, 108b.

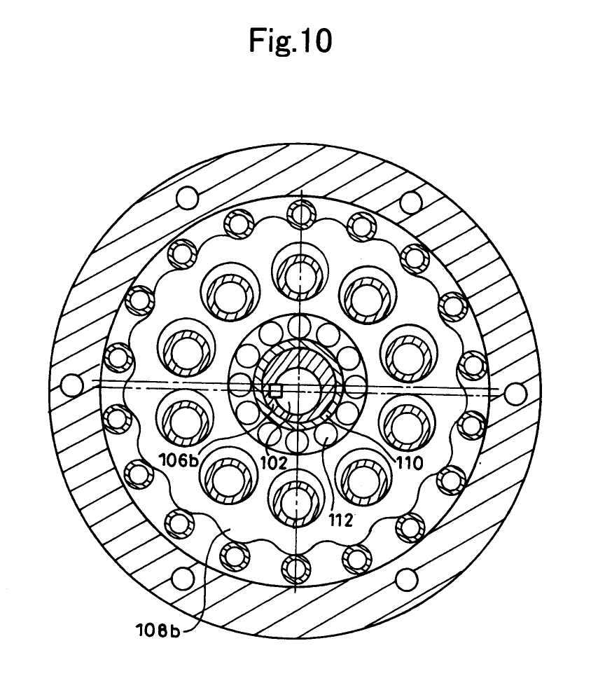

The support rings 224a are arranged ΔH1 radially outside the respective circles C1 which connect the rolling centers L2 of the rollers 222. Besides, the support rings 224a are perforated with the plurality of pockets 224b which allow the rollers 222 to be partially exposed to outside the support rings 224a. It is therefore possible to reduce the gaps between adjoining rollers 222 (from conventional ΔL1 (FIG. 10) to ΔL2), with the result that the rollers 222 can be increased in number for increased load capacity of the sliding structures 230. To be more specific, the inner peripheries of the support rings 224a desirably lie at least 1.05 times radially outside with respect to the radius R of the circles C1 which connect the rolling centers L2 of the rollers 222 (R+ΔH1≧1.05R). The support rings may be elliptic as long as the inner peripheries of the support rings lie at least 1.05 times radially outside with respect to the outer diameter of the circles which connect the rolling centers of the rollers.

The support rings 224a of the retainers 224 are each extended into a pair of side rings 224c for preventing the rollers 222 from slipping off from the axial ends. The simple structure can thus prevent the rollers 222 from axial slip-off.

The inner support rings 226 are arranged ΔH2 radially inside the respective circles C1 which connect the rolling centers L2 of the rollers 222. In addition, the inner support rings 226 are perforated with the plurality of inner pockets 226a for allowing the rollers 222 to be partially exposed to the their inner sides. It is therefore possible to prevent the rollers 222 from slipping off radially inward, and retain the rollers 222 with higher reliability at the time of assembly in particular.

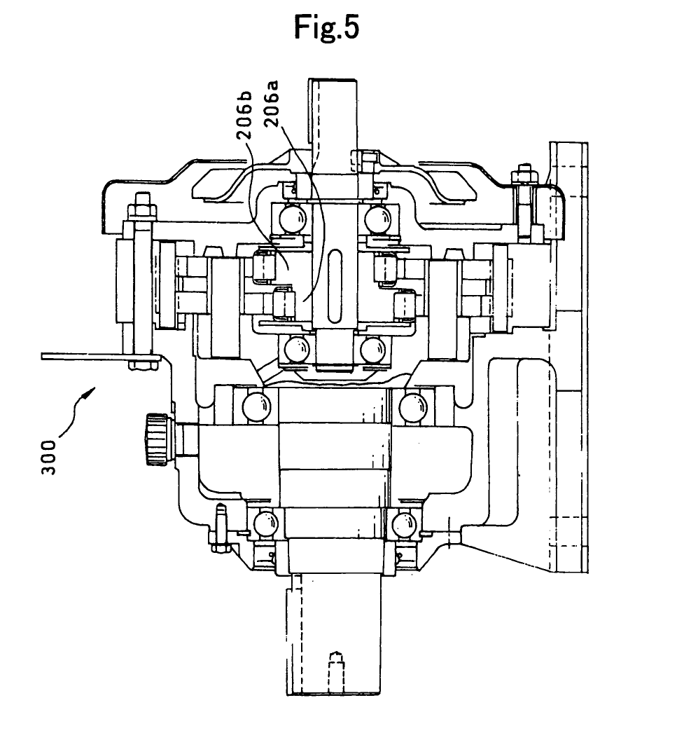

FIG. 5 is a sectional side view of a speed reducer 300 to which the sliding structure according to the embodiment of the present invention is applied. This diagram corresponds to FIG. 1 seen above.

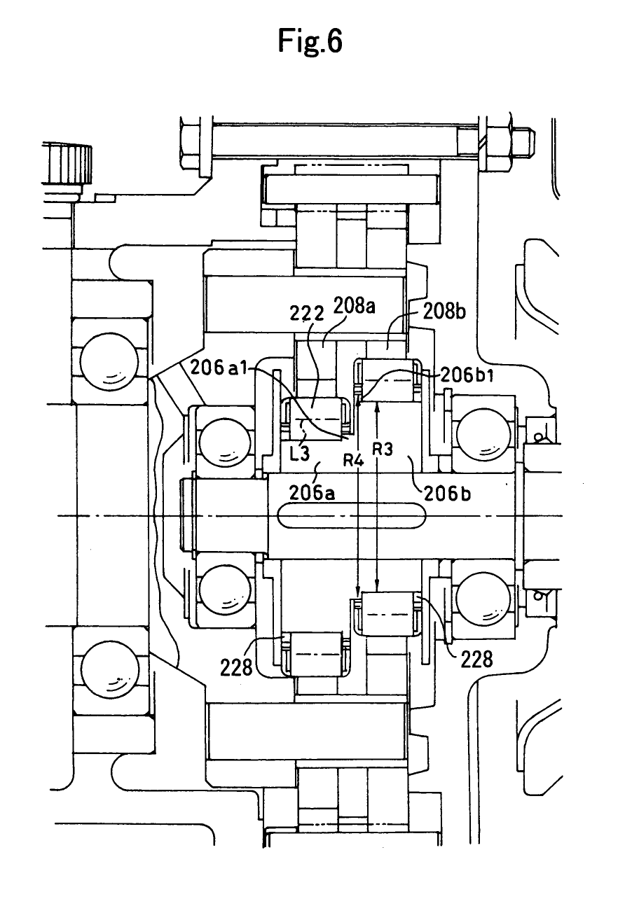

The speed reducer 300 shown in this FIG. 5 is substantially identical to the speed reducer 200 shown in FIG. 1 above, except in the configuration of eccentric bodies 206a and 206b. As shown in an enlarged partial view of FIG. 6, the eccentric bodies 206a and 206b are provided with protrusions 206a1 and 206b1 on their outer peripheries, respectively, at respective axial ends thereof. The protrusions 206a1 and 206b1 have a diameter R4 larger than the diameter R3 of the inscribed circles of the rollers 222.

The protrusions 206a1 and 206b1 arranged on the eccentric bodies 206a and 206b are both in contact with the rollers 222. The eccentric bodies 206a and 206b can thus function as positioning means for restraining the movement of the rollers 222 in the direction of the axis L3.

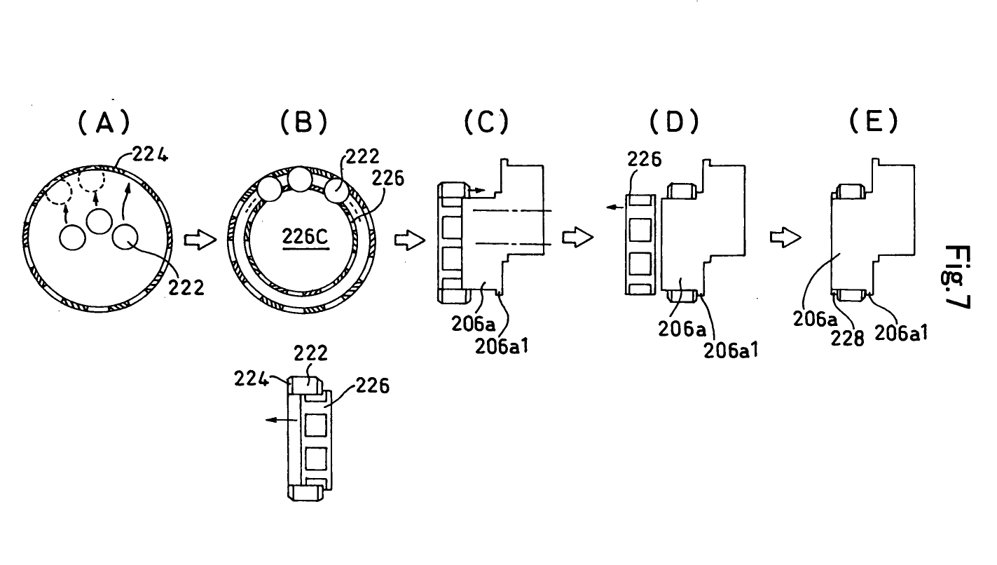

Next, with reference to FIGS. 7(A) to 7(E), description will be given of a method for assembling the eccentric bodies of the speed reducer to which the sliding structure according to the embodiment of the present invention is applied. FIGS. 7(A) to 7(E) are diagrams schematically showing the procedure for assembling an eccentric body according to a first example of the embodiment of the present invention.

For a concrete example, description will be given of the procedure for situations where the sliding structure 230 is assembled with the eccentric body 206a of the speed reducer 300 shown in FIG. 5.

Initially, the plurality of rollers 222 to be arranged between the eccentric body 206a and the external gear 208a are loaded from inside the retainer 224 for positioning (FIG. 7(A)). Next, the inner support ring 226 described previously is inserted into inside the loaded rollers 222 (FIG. 7(B)), whereby the radially inward movement of the rollers 222 is restrained. The eccentric body 206a is then inserted into the interior space 226a of this inner support ring 226 (FIG. 7(C)). Finally, the inner support ring 226 is pulled out (FIG. 7(D)) before an eccentric body ring (a rotor ring) 228 for restraining the axial movement of the rollers 222 is fitted to the outer periphery of the eccentric body 206a (FIG. 7(E)).

The rollers 222 are typically used in plural, and would thus require considerable labor if they were loaded from outside one by one. By using the assembly method described above, the rollers 222 can be loaded from inside the retainer 224 at a time, allowing short-time operation with an improvement in productivity. Moreover, the inner support ring 226 restrains the radially inward movement of the rollers 222, and makes the retainer 224 portable with the rollers 222 loaded in the retainer 224. The operation is thus facilitated further. Incidentally, the inner support ring 226 in the state of FIG. 7(C) need not necessarily be pulled out, in which case the inner support ring 226 constitutes part of the sliding structure 230 as is.

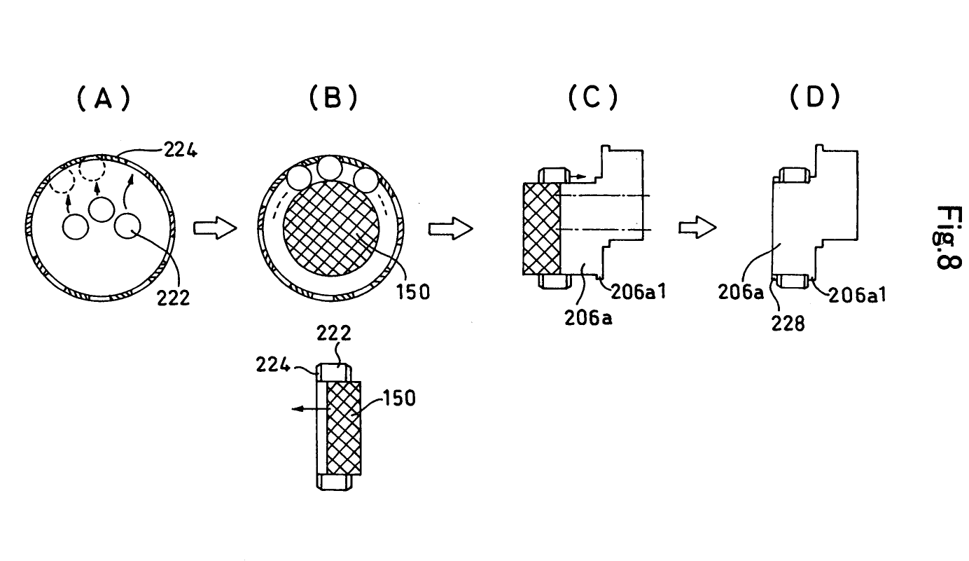

FIGS. 8(A) to 8(D) are diagrams schematically showing the procedure for assembling the eccentric body 206a according to a second example of the embodiment of the present invention. Here, a dummy eccentric body (a dummy rotor) 150 having almost the same shaft diameter as that of the eccentric body 206a is used instead of the inner support ring 226.

In this assembly method, the plurality of rollers 222 to be arranged between the eccentric body 206a and the external gear 208a are initially loaded from inside the positioning retainer 224 (FIG. 8(A)). Next, the dummy eccentric body 150 is inserted into inside the loaded rollers 222 (FIG. 8(B)). Finally, the dummy eccentric body 150 and the eccentric body 206a are aligned with each other, and the retainer 224 is moved toward the eccentric body 206a so that the dummy eccentric body 150 is replaced with the eccentric body 206a (FIG. 8(C)). The eccentric body ring 228 for restraining the axial movement of the rollers 222 is then fitted to the outer periphery of the eccentric body 206a (FIG. 8(D)).

While the dummy eccentric body 150 is given the same shaft diameter as that of the eccentric body 206a, the present invention is not limited thereto. The dummy eccentric body (the dummy rotor) 150 has only to press the rollers 222 outward. For example, the dummy rotor may have a shaft diameter greater than that of the eccentric body 206a when the dummy rotor body is made of flexible material. The rollers 222 can thus be retained from inside to provide the same effect.

In this assembly method, the rollers 222 are merely positioned by the retainer 224, not loaded fixedly. The rollers 222 can thus be fine adjusted in position at the time of assembly of the eccentric body 206a, so that the assembly of the eccentric body 206a is facilitated as compared to the case where the rollers 222 are loaded fixedly.

In the foregoing embodiment, the rollers 222 are used as the rolling elements. However, the present invention is not limited thereto. Balls and other rolling elements may be used to constitute the sliding structures. The numbers of rolling elements are not limited to the shown examples, either. Moreover, the pockets 224b and the inner pockets 226a for accommodating the rolling elements are not limited to the shown shapes. For example, the pockets 224b and the inner pockets 226a are given circular shapes when balls are to be accommodated.

The method for assembling an eccentric body is not limited to those of the examples of the foregoing embodiment. Any method may be used as long as it includes the steps of: loading a plurality of rolling elements to be arranged between the eccentric element and the oscillator via a retainer for positioning the rolling elements from inside the retainer; and assembling the eccentric body into inside the loaded rolling elements.

Incidentally, aside from the eccentric bodies, the “rotor” as employed in the present invention also includes ones that make rotations about themselves along with flexible movement of the external gears (oscillators). An example thereof is the wave generator of flexible meshing planetary gearing. Aside from the external gears, the “oscillator” as employed in the present invention also includes an internal gear of internal gear oscillating planetary gearing in which the internal gear makes oscillations.

The present invention may be used for a power supply device that comprises an eccentric body (eccentric bodies) capable of eccentric rotations about the center axis of input shaft and an oscillator (oscillators) capable of oscillations along with the rotations of the eccentric body (eccentric bodies).

What is claimed is:

1. A method for assembling a rotor of a power transmission device having an oscillator and a rotor rotatably assembled into said oscillator, said rotor making rotations and oscillations of said oscillator, the method comprising the steps of:
loading a plurality of rolling elements to be arranged between said rotor and said oscillator via a retainer for positioning said rolling elements, from inside said retainer; and
assembling said rotor into inside said loaded rolling elements.

2. The method for assembling a rotor according to claim 1, wherein the step of assembling said rotor into inside said loaded rolling elements includes the substeps of:
inserting an inner support ring into inside said loaded rolling elements, said inner support ring being arranged radially inside a circle connecting the rolling centers of said rolling elements and perforated with a plurality of inner pockets for allowing said rolling elements to be partially exposed to its inner side;
inserting said rotor into an interior space of said inner support ring.

3. The method for assembling a rotor according to claim 2, includes the substep of pulling out said inner support ring.

4. The method for assembling a rotor according to claim 1, wherein the step of assembling said rotor into inside said loaded rolling elements includes the substeps of:
inserting a dummy rotor pressing said loaded rolling elements outward; and
inserting said rotor so as to replace said dummy rotor.

5. The method for assembling a rotor according to claim 1, wherein the step of assembling said rotor into inside said loaded rolling elements includes the substeps of:
inserting a dummy rotor having almost the same shaft diameter as that of said rotor into inside said rolling elements; and
inserting said rotor so as to replace said dummy rotor.

6. The method for assembling a rotor according to claim 1, wherein
the step of assembling said rotor is followed by step of fitting a rotor ring for restraining axial movement of said rolling elements onto an outer periphery of said rotor.

7. A sliding structure of a rotor and an oscillator of a power transmission device having an oscillator and a rotor rotatably assembled into said oscillator, said rotor making rotations and oscillations of said oscillator, the sliding structure comprising:
a plurality of rolling elements arranged between said rotor and said oscillator; and
a retainer having a support ring being arranged radially outside a circuit connecting the rolling centers of said rolling elements and perforated with a plurality of pockets for allowing said rolling elements to be partially exposed to its outer side, wherein
a protrusion for restraining axial movement of said rolling elements is provided on only one axial end of an outer periphery of said rotor.

8. The sliding structure of a rotor and an oscillator according to claim 7, wherein
said retainer has side ring being extended from an axial end of said support ring to avoid said rolling elements from slipping off.

9. The sliding structure of a rotor and an oscillator according to claim 7, wherein
an inner periphery of said support ring lies at least 1.05 times radially outside the circle connecting the rolling centers of said rolling elements.
